(19) United States
(12) Patent Application Publication
(10) Pub. No.: US 2010/0320786 A1
(43) Pub. Date: Dec. 23, 2010

(54) NONCONTACT TYPE SUCTION GRIPPING DEVICE AND NONCONTACT TYPE SUCTION GRIPPING FRAME HAVING THE SAME

(76) Inventors: Youngchae Ko, Chungcheongnam-do (KR); Hyukki Kwon, Chungcheongnam-do (KR); Taeho Keem, Chungcheongnam-do (KR); Changha Lee, Chungcheongnam-do (KR); Youngtae Kim, Daejeon (KR); Young Bae Chang, Stillwater, OK (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/732,717

(22) Filed: Mar. 26, 2010

(30) Foreign Application Priority Data
Apr. 7, 2009 (KR) 10-2009-0029816

(51) Int. Cl. B25J 15/06; B66C 1/02

(52) U.S. Cl. 294/64.3

(57) ABSTRACT

A noncontact type suction gripping device suitable for lifting a flat object in a noncontact manner includes a housing section including a pressing part which forms a closed surface when being placed to closely face one surface of a flat object, an R part which extends from the pressing part to be convexly rounded when viewed from the flat object, a sidewall part which is formed such that at least a portion thereof linearly extends from the R part in a direction facing away from the flat object, and an air inlet part which is connected to the sidewall part to introduce air, supplied from the outside, into the housing section; and a nozzle section including a nozzle tip which is separated from an inner surface of the sidewall part by a predetermined gap such that air supplied through the air inlet part can be discharged toward the perpendicular direction on the flat object, and an inclined surface which is formed to have a gradually decreasing diameter from the nozzle tip toward the air inlet part, the nozzle section having a funnel-shaped configuration and being inserted into a space defined in the housing section.

### BACKGROUND OF THE INVENTION

1. Field of the Invention

The present invention relates to a noncontact type suction gripping device and a noncontact type suction gripping frame having the same, and more particularly, to a noncontact type suction gripping device which can lift a flat object such as a glass in a noncontact type using vacuum and a noncontact type suction gripping frame having the same.

2. Description of the Related Art

In general, flat objects such as glasses, steel plates and semiconductor wafers need be conveyed by being sucked on any one surface of each of them in manufacturing processes and post-processes adopted after manufacture. Exemplifying a flat glass for a display, the manufacturing processes requiring suction include a process for cutting the flat glass to an appropriate size and a process for grinding the sides of the cut glass pieces to be rounded, and the post-processes adopted after manufacture and requiring suction include a process for patterning circuits on a flat glass substrate.

The flat glass for a display requires high degree of surface smoothness and flatness. In this connection, if scratches are formed on the surface of the flat glass, since the scratches are likely to cause defects in some pixels of a completely manufactured display device, precise inspection is required.

Moreover, a glass panel, which has been developed as a glass substrate for a next-generation display, is thin and is sized large in such a way as to have a width and a length that respectively correspond to about 2 m. If both ends of the large-sized glass substrate for a display are grasped and lifted, the glass substrate is likely to quiver due to sagging of the center portion thereof, and thus, a complicated structure is needed to safely invert the glass substrate.

In this regard, if a contact pad, which contacts the flat glass when conveying or inverting the flat glass, is employed, the surfaces of the flat glass are likely to be contaminated. Under these situations, research has been made to develop a device capable of lifting a flat object in a noncontact manner. Describing an example of a conventional noncontact type suction gripping device with reference to FIG. 1, vacuum suction force is applied from the outside to the center portion of a flat glass G through a vacuum hose 121, and air having a sufficiently high pressure is supplied around the center portion of the flat glass G, to which the vacuum suction force is applied, through a compressed air hose 122 such that the device is prevented from coming into contact with the surface of the flat glass G.

However, in the conventional noncontact type suction gripping device, in order to create a vacuum condition, it is necessary to supply air of 2˜7 atm. In order to create this vacuum pressure, a compressor is needed. Since the compressor for providing the vacuum pressure cannot be placed in a clean room, a problem is caused in that separate expensive equipment such as a CDA (clean dry air) system must be employed. Also, in the conventional noncontact type suction gripping device, the distance between the flat glass and the noncontact type suction gripping device is maintained at 0.2 mm to 0.3 mm. If the distance is maintained at this level, the flat glass is likely to come into contact with the noncontact type suction gripping device, which causes a problem.

### SUMMARY OF THE INVENTION

Accordingly, the present invention has been made in an effort to solve the problems occurring in the related art, and an object of the present invention is to provide a noncontact type suction gripping device which can lift a flat object such as a glass in a noncontact type using a pneumatic pressure no greater than 0.3 atmospheric pressure without using separate expensive equipment and a noncontact type suction gripping frame having the same.

In order to achieve the above object, according to one aspect of the present invention, there is provided a noncontact type suction gripping device suitable for lifting a flat object in a noncontact manner, comprising a housing section including a pressing part which forms a closed surface when being placed to closely face one surface of a flat object, an R part which extends from the pressing part to be convexly rounded when viewed from the flat object, a sidewall part which is formed such that at least a portion thereof linearly extends from the R part in a direction facing away from the flat object, and an air inlet part which is connected to the sidewall part to introduce air, supplied from the outside, into the housing section; and a nozzle section including a nozzle tip which is separated from an inner surface of the sidewall part by a predetermined gap such that air supplied through the air inlet part can be discharged toward the perpendicular direction on the flat object, and an inclined surface which is formed to have a gradually decreasing diameter from the nozzle tip toward the air inlet part, the nozzle section having a funnel-shaped configuration and being inserted into a space defined in the housing section.

According to another aspect of the present invention, the nozzle tip is formed at a position that is depressed toward the air inlet part when viewed from the pressing part.

According to another aspect of the present invention, the nozzle tip is positioned to be closer to the air inlet part when viewed from a border line between the R part and the sidewall part of the housing section.

According to another aspect of the present invention, the housing further includes an external R part which is formed to be convexly rounded upward from the pressing part in a direction facing away from the flat object when viewed from the flat object.

According to another aspect of the present invention, the housing section and the nozzle section are formed such that each of the horizontal sections thereof is symmetric with respect to a center of the closed surface, formed by the pressing part, on a virtual horizontal plane on which the flat object is placed.

Actually, the pressing part can be any shape type if it has closed surface but the pressing part has any one sectional shape selected from a circular sectional shape, a quadrangular sectional shape, and an elliptical sectional shape in considering the cost of design and manufacturing.

In order to achieve the above object, according to still another aspect of the present invention, there is provided a noncontact type suction gripping frame comprising a frame having a plurality of horizontal bars; and a plurality of noncontact type suction gripping devices attached to the horizontal bars of the frame, each noncontact type suction gripping device comprising a housing section including a pressing part which forms a closed surface when being placed to closely face one surface of a flat object, an R part which extends from the pressing part to be convexly rounded when viewed from the flat object, a sidewall part which is formed such that at least a portion thereof linearly extends from the R part in a direction facing away from the flat object, and an air inlet part which is connected to the sidewall part to introduce air, supplied from the outside, into the housing section; and a nozzle section including a nozzle tip which is separated from an inner surface of the sidewall part by a predetermined gap such that air supplied through the air inlet part can be discharged along the R part, and an inclined surface which is formed to have a gradually decreasing diameter from the nozzle tip toward the air inlet part, the nozzle section having a funnel-shaped configuration and being inserted into a space defined in the housing section.

According to a still further aspect of the present invention, the nozzle tip is positioned to be closer to the air inlet part when viewed from a border line between the R part and the sidewall part of the housing section.

The above objects, and other features and advantages of the present invention will become more apparent after a reading of the following detailed description taken in conjunction with the drawings. Before describing the embodiments of the present invention, considering the notion that an inventor can most properly define the concepts of the terms or words used in this description and the following claims to best explain his or her invention, the terms or words must be understood as having meanings or concepts that conform to the technical spirit of the present invention.

### BRIEF DESCRIPTION OF THE DRAWINGS

FIG. 1 is a sectional view illustrating a conventional noncontact type suction gripping device;

FIG. 2 is a sectional view illustrating a noncontact type suction gripping device in accordance with one embodiment of the present invention;

FIG. 3 is a sectional view explaining the flow of air and the action of pressures on a flat glass in the noncontact type suction gripping device in accordance with one embodiment of the present invention;

FIG. 4 is a perspective view illustrating a state in which a small-sized flat glass is lifted and then inverted using the noncontact type suction gripping device in accordance with one embodiment of the present invention;

FIG. 5 is a schematic sectional view explaining a quivering phenomenon that occurs in the case where the noncontact type suction gripping device in accordance with one embodiment of the present invention is applied to a plate member having a small thickness;

FIG. 6 is a sectional view illustrating a noncontact type suction gripping device in accordance with another embodiment of the present invention;

FIG. 7 is of views illustrating various closed surfaces which can be formed by a pressing part of the noncontact type suction gripping device according to the present invention; and

FIG. 8 is of perspective views illustrating a noncontact type suction gripping frame in accordance with still another embodiment of the present invention, which is constituted using a plurality of noncontact type suction gripping devices.

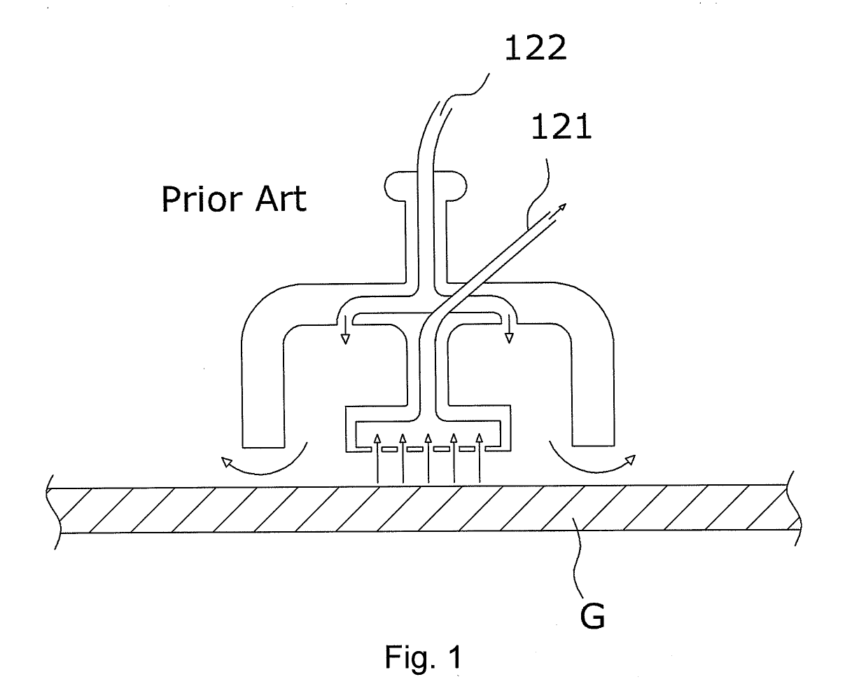

### DETAILED DESCRIPTION OF PREFERRED EMBODIMENTS

Reference will now be made in greater detail to preferred embodiments of the invention, examples of which are illustrated in the accompanying drawings. Wherever possible, the same reference numerals will be used throughout the drawings and the description to refer to the same or like parts.

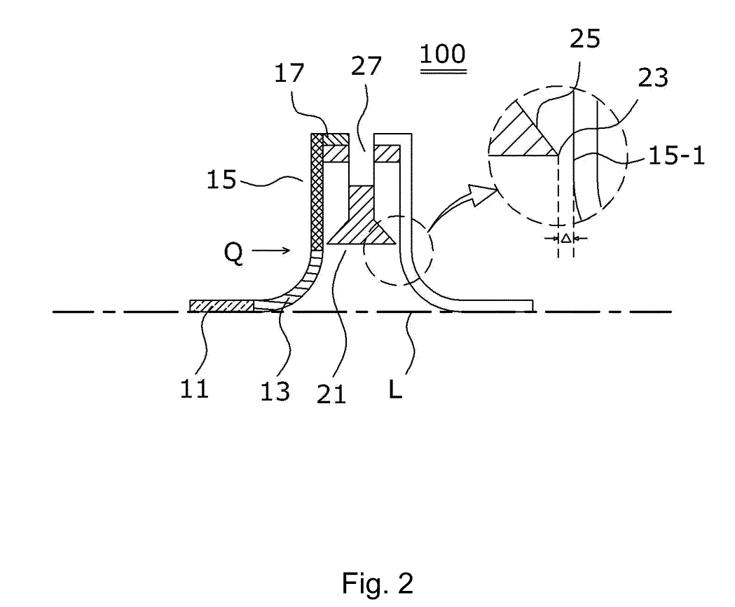

FIG. 2 is a sectional view illustrating a noncontact type suction gripping device in accordance with one embodiment of the present invention. The noncontact type suction gripping device 100 in accordance with one embodiment of the present invention is composed of a housing section and a nozzle section which induce the Coanda effect. The housing section includes a pressing part 11 which forms a closed surface when being placed to closely face one surface of a flat object, an R part 13 which extends from the pressing part 11 to be convexly rounded when viewed from the flat object, a sidewall part 15 which is formed such that at least a portion thereof linearly extends from the R part 13 in a direction facing away from the flat object, and an connecting part 17 which is connected to the sidewall part 15 to form an air inlet part 27, supplying air from the outside into the housing section. The nozzle section 21 substantially has a funnel-shaped configuration. As shown in FIG. 2, the nozzle section 21 includes a nozzle tip 23 which is separated from the inner surface 15-1 of the sidewall part 15 by a gap Δ that is narrow to such an extent that air can barely pass through it, and an inclined surface 25 which is formed to have a gradually decreasing diameter from the nozzle tip 23 toward the air inlet part 27. The nozzle section 21, which substantially has the funnel-shaped configuration, is inserted into the space defined in the housing section. Component elements for inducing the Coanda effect include the pressing part 11, the R part 13, the sidewall part 15, and the nozzle section 21. Therefore, since the configuration of the air inlet part 27 and a method for supplying air do not constitute the characterizing features of the present invention, they can be changed in a variety of ways.

Referring to FIG. 2, in the noncontact type suction gripping device 100 in accordance with one embodiment of the present invention, the pressing part 11 can be any shape with closed surface if the pressing part can give vacuum suction force to flat object. But preferably, the pressing part 11 is formed in such a way as to be symmetric with respect to the center of the closed surface such that the pressing part 11 can form the closed surface in cooperation with a virtual horizontal plane L considering the cost of design and manufacturing. Speaking this more concretely, the housing section and the nozzle section 21 are formed such that each of the horizontal sections thereof is symmetric with respect to the center of the closed surface, formed by the pressing part 11, on the virtual horizontal plane on which the flat object is placed.

Also, in order to apply suction force to the flat object on the closed surface formed by the pressing part 11, the nozzle tip 23 is positioned upward to be closer to the air inlet part 27 than to the virtual horizontal plane L, such that an empty space can be defined by the closed surface, the R part 13, the sidewall part 15 and the nozzle section 21. More preferably, in order to reliably attain the Coanda effect, the nozzle tip 23 is positioned to be closer to the air inlet part 27 when viewed from a border line Q between the R part 13 and the sidewall part 15 of the housing section. The border line Q means the location point which ends the R part 13 and starts the sidewall part 15.

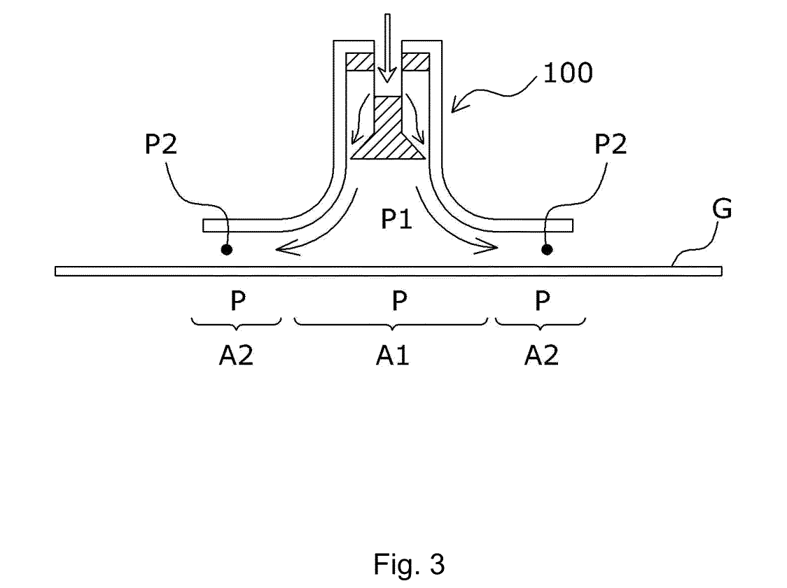

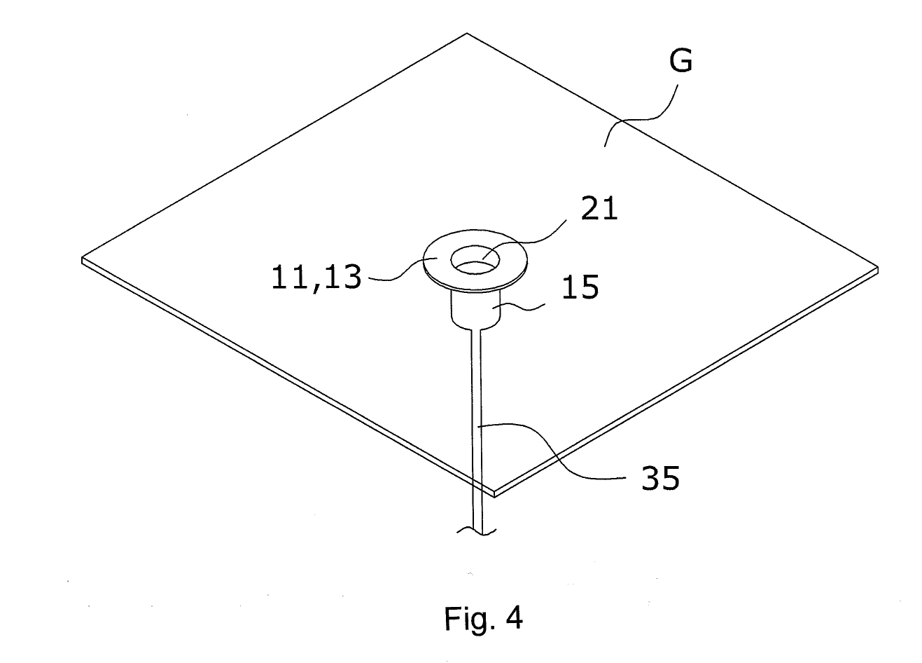

FIG. 3 is a sectional view explaining the flow of air and the action of pressures on a flat glass in the noncontact type suction gripping device in accordance with one embodiment of the present invention, and FIG. 4 is a perspective view illustrating a state in which a small-sized flat glass is lifted and then inverted using the noncontact type suction gripping device in accordance with one embodiment of the present invention. As shown in FIG. 3, the air supplied through the air inlet part 27 flows along the inclined surface 25 of the nozzle section 21. Then, after passing between the nozzle tip 23 and the inner surface 15-1 of the housing section, the air flows along the R part 13 and is discharged to the outside through the pressing part 11.

The Coanda effect indicates a phenomenon in which a jet flow attaches itself to a nearby surface and remains attached even when the surface curves away from the initial jet direction. In the noncontact type suction gripping device according to the present invention, the Coanda effect is employed such that supplied air can flow along the R part 13 of the housing section so that suction force and repulsive force can be applied to the flat object. Referring to FIG. 3, in the noncontact type suction gripping device according to the present invention, as the supplied air flows, a pressure P1 of the internal space which is defined by the flat glass G, the housing section and the surface of the nozzle tip 23 is developed lower than a surrounding pressure P. That is to say, as an inequality, P1<P is satisfied, suction force for sucking the flat glass G toward the noncontact type suction gripping device 100 is generated in the area denoted by the reference symbol A1. On the other hand, a pressure P2 at the pressing part 11 is developed higher than the surrounding pressure P by the air that flows at a high speed from the R part 13 to the pressing part 11. That is to say, as an inequality, P2>P is satisfied, repulsive force for repelling the flat glass G from the noncontact type suction gripping device 100 is generated in the area denoted by the reference symbol A2.

As a consequence, in the noncontact type suction gripping device 100 according to the present invention, the suction force and the repulsive force are applied to the flat glass G using air that is supplied through an air supply hose 35 and has a relatively low pressure, so that the flat glass G can be lifted in a noncontact manner as shown in FIG. 4. In this regard, while the conventional noncontact type suction gripping device requires highly compressed air over 2 atm, in the noncontact type suction gripping device according to the present invention which employs the Coanda effect, it is sufficient to supply air of about 0.3 atm. Accordingly, in the conventional noncontact type suction gripping device, a compressor installed outside a clean room and a CDA system are needed, whereas, in the case of the noncontact type suction gripping device according to the present invention, air can be sufficiently supplied even by using a ring blower as a kind of a blower.

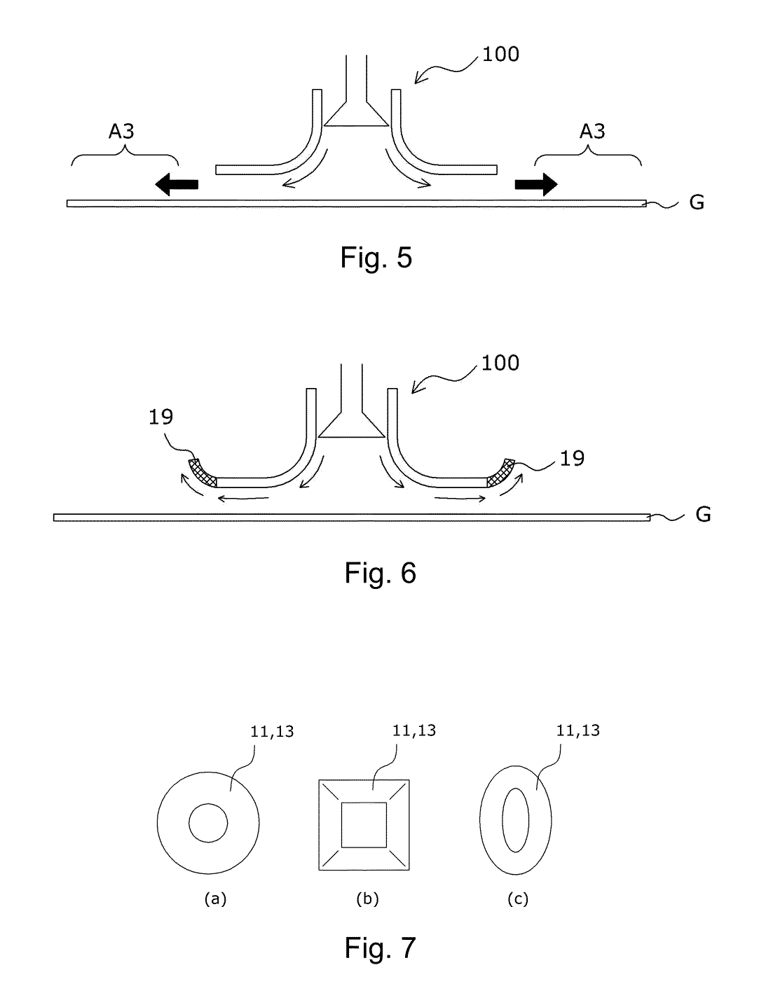

Meanwhile, in the case of lifting a flat object comprising a thin plate member using the noncontact type suction gripping device 100 according to the present invention, a quivering phenomenon can occur in portions of the plate member by the air flow discharged out of the pressing part. FIG. 5 is a schematic sectional view explaining a quivering phenomenon that occurs in the case where the noncontact type suction gripping device in accordance with one embodiment of the present invention is applied to a plate member having a small thickness. Referring to FIG. 5, a quivering phenomenon can occur in a plate member G having a small thickness in the area denoted by the reference symbol A3 due to the air flow that is discharged out of the pressing part of the noncontact type suction gripping device.

FIG. 6 is a sectional view illustrating a noncontact type suction gripping device in accordance with another embodiment of the present invention. Hereinbelow, only the differences over the noncontact type suction gripping device shown in FIG. 2 will be described. Referring to FIG. 6, an external R part 19 is additionally formed such that the external R part 19 is convexly rounded upward from the pressing part in a direction facing away from the flat glass G when viewing the flat glass G from the housing section. Due to the presence of the external R part 19 formed in this way, after the supplied air flows along the R part and is discharged out of the pressing part, the flow of the discharged air is changed in the direction facing away from the flat glass G. Therefore, even when the noncontact type suction gripping device 100 according to the present invention is applied to a plate member having a small thickness, the quivering phenomenon can be substantially prevented.

Further, in the case where a blower for sucking air outside is additionally installed above the external R part 19, the amount of air discharged through the external R part 19 to the outside can be adjusted by the additionally installed blower, so that the flat glass G can be easily lifted or put down by the noncontact type suction gripping device 100. In the event that the flat glass G is lifted using the noncontact type suction gripping device 100, the blower installed above the external R part 19 is turned off or operated at a low speed, and in the event that the flat glass G is put down using the noncontact type suction gripping device 100, the blower installed above the external R part 19 is operated at a high speed so that a discharge amount of air can be increased.

FIG. 7 is of views illustrating various closed surfaces which can be formed by a pressing part of the noncontact type suction gripping device according to the present invention. Referring to FIG. 7, the pressing part of the noncontact type suction gripping device can be formed to have various closed surfaces depending upon the kind of a flat object to be handled, such as a circular one shown in (a), a quadrangular one shown in (b) and an elliptical one shown in (c).

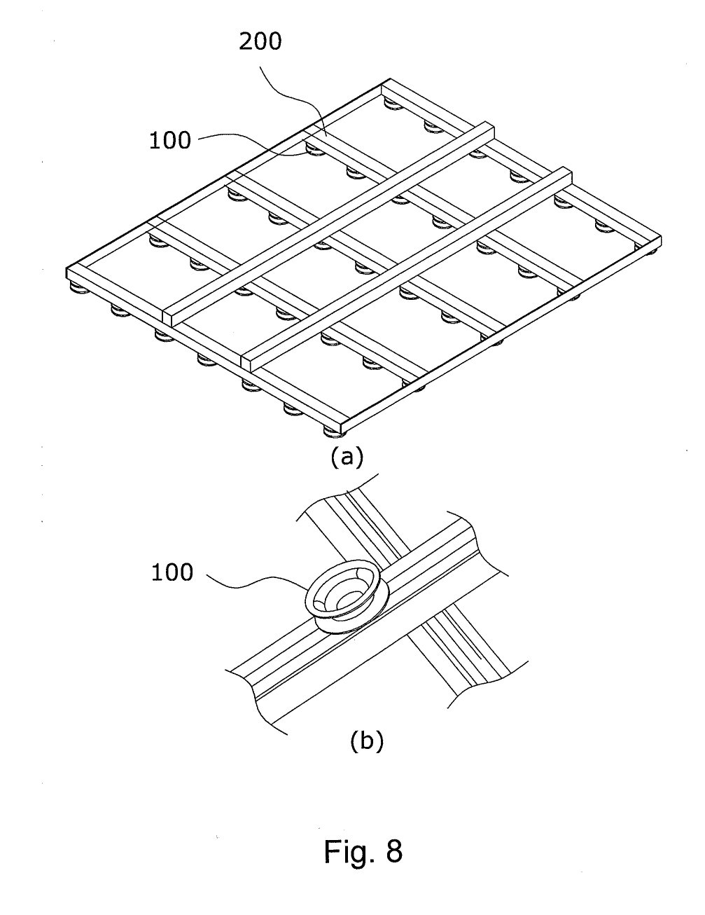

FIG. 8 is of perspective views illustrating a noncontact type suction gripping frame in accordance with still another embodiment of the present invention, which is constituted using a plurality of noncontact type suction gripping devices. A noncontact type suction gripping frame 200 has a plurality of transverse bars and a plurality of longitudinal bars. A plurality of noncontact type suction gripping devices 100 are installed at regular intervals on the lower surfaces of the transverse bars. The noncontact type suction gripping frame 200 shown in FIG. 8 constitutes an embodiment that is suitable for lifting a flat object which has a wide area. While not shown in the drawing, compressed air should be supplied to the noncontact type suction gripping devices 100. The compressed air can of course be supplied by forming air nozzles in the transverse bars and the longitudinal bars or by way of separate air nozzles.

As is apparent from the above description, the noncontact type suction gripping device according to the present invention can be operated through the supply of air using energy corresponding to 1/30 when compared to the conventional noncontact type suction gripping device. The conventional noncontact type suction gripping device generally operates at 4 to 7 atm, and it is recently known that a device operating at about 2 atm is under test-driving. In the present invention, since the noncontact type suction gripping device employs the Coanda effect, it can be operated at 0.3 atm as a very low pressure compared to the conventional art.

In the conventional art, a compressor should be installed outside a clean room so as to supply air of a high pressure, and a CDA system should be employed as an additional device so as to purify air. In the present invention, because the noncontact type suction gripping device can be operated at a low pressure, the air which is currently used in a clean room can be used as it is. Even when the air which is currently used in a clean room cannot be used, since supplied air has a low pressure, advantages are provided in that a ring blower to be installed outside the clean room can be employed.

In the conventional noncontact type suction gripping device, it is known that the noncontact distance between the surface of the device and a flat object is maintained below 0.3 mm. Therefore, in the conventional noncontact type suction gripping device, since the noncontact distance between the surface of the device and the flat object is too small, when handling the flat object using the conventional noncontact type suction gripping device, it is a frequent occurrence that the flat object touches the surface of the device. This reason to this resides in that, because the conventional noncontact type suction gripping device uses a highly pressurized air, the flow rate of air passing between the surface of the device and the surface of the flat object increases, and due to this fact, the noncontact distance between the surface of the device and the surface of the flat object decreases. Conversely, in the noncontact type suction gripping device according to the present invention, since a low pressure below 0.3 atm is used, the flow rate of air passing between the surface of the device (that is, a pressing part) and the surface of the flat object decreases, and due to this fact, even when lifting the flat object, the noncontact distance between the pressing part and the flat object can be sufficiently maintained to be substantial. Accordingly, when the noncontact type suction gripping device according to the present invention is employed, there is no possibility of scratches to be formed on the flat object.

Although preferred embodiments of the present invention have been described for illustrative purposes, those skilled in the art will appreciate that various modifications, additions and substitutions are possible, without departing from the scope and the spirit of the invention as disclosed in the accompanying claims.

1. A noncontact type suction gripping device suitable for lifting a flat object in a noncontact manner, comprising:
a housing section including a pressing part which forms a closed surface when being placed to closely face one surface of a flat object, an R part which extends from the pressing part to be convexly rounded when viewed from the flat object, a sidewall part which is formed such that at least a portion thereof linearly extends from the R part in a direction facing away from the flat object, and an connecting part which is connected to the sidewall part to form an air inlet part, supplying air from the outside into the housing section; and
a nozzle section discharging air supplied through the air inlet part toward the perpendicular direction on the flat object, wherein the nozzle section includes a nozzle tip which is separated from an inner surface of the sidewall part by a predetermined gap, and the nozzle section has a funnel-shaped configuration having an inclined surface which is formed to have a gradually decreasing diameter from the nozzle tip toward the air inlet part, and the nozzle section is inserted into a space defined in the housing section.

2. The noncontact type suction gripping device according to claim 1, wherein the nozzle tip is formed at a position that is depressed toward the air inlet part when viewed from the pressing part.

3. The noncontact type suction gripping device according to claim 2, wherein the nozzle tip is positioned to be closer to the air inlet part when viewed from a border line between the R part and the sidewall part of the housing section.

4. The noncontact type suction gripping device according to claim 1, wherein the housing further includes an external R part which is formed to be convexly rounded upward from the pressing part in a direction facing away from the flat object when viewed from the flat object.

5. The noncontact type suction gripping device according to claim 1, wherein the housing section and the nozzle section are formed such that each of the horizontal sections thereof is symmetric with respect to a center of the closed surface, formed by the pressing part, on a virtual horizontal plane on which the flat object is placed.

6. The noncontact type suction gripping device according to claim 1, wherein the pressing part has any one sectional shape selected from a circular sectional shape, a quadrangular sectional shape, and an elliptical sectional shape.

7. A noncontact type suction gripping frame comprising:
a frame having a plurality of horizontal bars; and
a plurality of noncontact type suction gripping devices attached to the horizontal bars of the frame,
each noncontact type suction gripping device comprising
a housing section including a pressing part which forms a closed surface when being placed to closely face one surface of a flat object, an R part which extends from the pressing part to be convexly rounded when viewed from the flat object, a sidewall part which is formed such that at least a portion thereof linearly extends from the R part in a direction facing away from the flat object, and an air inlet part which is connected to the sidewall part to introduce air, supplied from the outside, into the housing section; and
a nozzle section discharging air supplied through the air inlet part toward the perpendicular direction on the flat object, wherein the nozzle section includes a nozzle tip which is separated from an inner surface of the sidewall part by a predetermined gap, and the nozzle section has a funnel-shaped configuration having an inclined surface which is formed to have a gradually decreasing diameter from the nozzle tip toward the air inlet part, and the nozzle section is inserted into a space defined in the housing section.

8. The noncontact type suction gripping frame according to claim 7, wherein the nozzle tip is positioned to be closer to the air inlet part when viewed from a border line between the R part and the sidewall part of the housing section.
